(19) United States
(12) Patent Application Publication
(10) Pub. No.: US 2015/0162608 A1
(43) Pub. Date: Jun. 11, 2015

(54) METAL HYDRIDE, METAL HYDRIDE PARTICLES, ELECTRODE FOR ALKALINE STORAGE BATTERY, AND ALKALINE STORAGE BATTERY

(71) Applicant: Toyota Jidosha Kabushiki Kaisha, Toyota-shi Aichi-ken (JP)

(72) Inventors: Tomoya Matsunaga, Susono-shi (JP); Tamio Shinozawa, Numazu-shi (JP)

(21) Appl. No.: 14/551,483

(22) Filed: Nov. 24, 2014

(30) Foreign Application Priority Data
Dec. 6, 2013 (JP) 2013-252891

(51) Int. Cl. H01M 4/38; H01M 10/24

(52) U.S. Cl. CPC H01M 4/383; H01M 10/24

(57) ABSTRACT

The invention provides a metal hydride that has a main phase having a body-centered cubic structure, and that has a grain boundary phase including Ti and Ni. The metal hydride satisfies X/Y≧2.7, where X is the number of intersections between circles of a diameter equal to or greater than 84 μm and the grain boundary phase that appears in a scanning electron microscopy observation image of the metal hydride, before storage of hydrogen, the intersections being obtained by drawing the circles over the entire scanning electron microscopy observation image, and Y is the number of the circles drawn on the scanning electron microscopy observation image.

### INCORPORATION BY REFERENCE

The disclosure of Japanese Patent Application No. 2013-252891 filed on Dec. 6, 2013 including the specification, drawings and abstract is incorporated herein by reference in its entirety.

### BACKGROUND OF THE INVENTION

1. Field of the Invention

The invention relates to a metal hydride, metal hydride particles, an electrode for an alkaline storage battery having the metal hydride particle, and to an alkaline storage battery having the electrode.

2. Description of Related Art

Metal hydrides are used in applications such as electrodes for alkaline storage batteries. By increasing the hydrogen storage capacity of metal hydrides that are used in electrodes of alkaline storage batteries allows increasing the capacity of the alkaline storage battery.

Among technologies relating to such metal hydrides and alkaline storage batteries, for instance Japanese Patent Application Publication No. 8-236107 (JP 8-236107 A) discloses a metal hydride electrode that is made up of a metal hydride resulting from precipitating a second phase having a three-dimensional network structure and having Ti and Ni as main components, in a matrix having a hydrogen storage function, and of a porous foamed Ni substrate, such that pores in the foamed Ni substrate are filled with the metal hydride. The description (paragraph [0025]) of JP 8-236107 A indicates that the maximum particle size of the metal hydride is equal to or smaller than ⅓ of the 150-200 μm major axis of the pore diameter of the foamed Ni substrate before compression molding. Japanese Patent Application Publication No. 9-92271 (JP 9-92271 A) discloses a metal hydride electrode resulting from mixing predetermined amounts of a Ni powder and coated conductive particles that result from coating the surface of metal hydride particles with a conductive metal and subjecting then the resulting mixture to compression molding, wherein in the metal hydride particles, a second phase having a three-dimensional network structure and having Ti and Ni as main components is precipitated in a matrix having a hydrogen storage function. Japanese Patent Application Publication No. 8-269655 (JP 8-269655 A) discloses a metal hydride resulting from performing a heating treatment on a Ti-V solid solution alloy that is obtained by precipitating a second phase having a three-dimensional network structure and having Ti and Ni as main components, in a matrix having a hydrogen storage function. Japanese Patent Application Publication No. 2002-3975 (JP 2002-3975 A) discloses a metal hydride having a base phase made up of a Ti-V solid solution and having a body-centered cubic structure, and a second phase, made up of a Ti-Ni-based alloy and that is present in the form of a three-dimensional mesh in the base phase, as a result of which the latter is divided into small base phases; wherein the metal hydride is represented by composition formula TiₐV_{b}Ni_{c}M_{d} (in the formula, M denotes at least one element selected from the group consisting of Cr, Mn, Mo, Nb, Ta, W, La, Ce, Y, Mm, Co, Fe, Cu, Si, Al, B, Zr and Hf; Mm is a rare earth element mixture; 15≦a≦45; 35≦b≦70; 5≦c≦20; 0≦d≦8; and a+b+c+d=100), and the average cross-sectional area of the small base phases is equal to or smaller than 30 μm². Further, JP 2002-3975 A (paragraph [0016]) indicates that the metal hydride can be produced for instance through quenching and solidification, of an alloy molten metal of the above composition, at a cooling rate in excess of 10³ K/s, by resorting to a liquid quenching method (roll method, gas atomization or the like). Japanese Patent Application Publication No. 9-53134 (JP 9-53134 A) discloses a metal hydride having Ti, V and Ni, and in which a main phase has a body-centered cubic structure, wherein the metal hydride has a second phase made up mainly of Ti and Ni a having a size of 10 μm or less. Further, JP 9-53134 A (paragraph [0012]) discloses the feature of classifying the crushed alloy to 75 μm or less by causing hydrogen to be stored in and desorbed from the alloy.

Metal hydrides such as MmNi₅-based alloys (Mm is misch metal), TiZr-based alloys, Mg₂Ni-based alloys and the like (hereafter also referred to as “homogeneous composition MH”) are used in electrodes of alkaline storage batteries, in a fine-powder state where the average particle size of the alloy is about 50 μm or less. In these alloys, the entirety of the alloy exhibits a substantially homogeneous composition, and, accordingly, significant differences in reaction activity derived from differences in particle size are not readily observed. In a metal hydride that includes a main phase having a body-centered cubic structure and a grain boundary phase having Ti and Ni as main constituent elements, by contrast, the grain boundary phase that is present at the surface contributes significantly to reaction activity. In a case where the metal hydride is in a fine-powder state, the number of grain boundary phases present at the surface decreases readily, and hence it is difficult to achieve good characteristics. In the technology disclosed of JP 8-236107A, the metal hydride is used in a fine-powder state with an average particle size of about 50 μm. Accordingly, it is difficult to increase discharge capacity even when the metal hydride is used in an alkaline storage battery. In order to achieve good characteristics even when using such a metal hydride in a fine-powder state, it would be conceivable to resort to the technology disclosed in document JP 2002-3975 A, involving for instance liquid quenching, to achieve a finer mesh of the grain boundary phase, and cause thereby the grain boundary phase to be exposed at the surface of a metal hydride powder having a small particle size. Such an approach, however, involves a high-cost, low-productivity process, and it has thus been difficult to obtain a metal hydride that satisfies all the above characteristics of low cost, high productivity and high discharge capacity, through combinations of any of the technologies disclosed of JP 8-236107 A, JP 9-92271 A, JP 8-269655 A, JP 2002-3975 A and JP 9-53134 A.

### SUMMARY OF THE INVENTION

The invention provides a metal hydride, metal hydride particles, an electrode for an alkaline storage battery having the metal hydride particles, and an alkaline storage battery having the electrode, that allow increasing discharge capacity, at a low cost and with high productivity.

As a result of painstaking studies, the inventors found that by prescribing an average particle size to be equal to or greater than a predetermined size, and prescribing a predetermined number of grain boundary phases to be exposed at the surface, in a metal hydride made up of a main phase having a body-centered cubic structure and a grain boundary phase having Ti and Ni as main constituent elements, it becomes possible to increase the discharge capacity of an alkaline storage battery in which that metal hydride is used, even when the metal hydride is produced without resorting to a high-cost and low-productivity process such as those in the related art. The inventors perfected the invention on the basis of that finding.

A first aspect of the invention relates to a metal hydride that has a main phase having a body-centered cubic structure, and that has a grain boundary phase including Ti and Ni. The metal hydride satisfies X/Y≧2.7, where X is the number of intersections between circles of a diameter equal to or greater than 84 μm and the grain boundary phase that appears in a scanning electron microscopy observation image of the metal hydride, before storage of hydrogen, the intersections being obtained by drawing the circles over the entire scanning electron microscopy observation image, and Y is the number of the circles drawn on the scanning electron microscopy observation image.

The grain boundary phase in the metal hydride of the invention is present in the form of a three-dimensional network, such that the main phase is divided into a plurality of regions by the grain boundary phase. Metal hydride particles in which the grain boundary phase is not exposed at the surface are produced readily when the average particle size of the metal hydride particles is set to be excessively small in the production of the metal hydride particles from the metal hydride. However, metal hydride particles in which an average of 2.7 or more grain boundary phases are exposed at the surface can be achieved by prescribing the average particle size D₅₀ to be equal to or greater than 84 μm. By virtue of having a grain boundary phase exposed at the surface, the metal hydride that has a main phase having a body-centered cubic structure, and that has a grain boundary phase including Ti and Ni, elicits the effect of making it possible to increase the discharge capacity of an alkaline storage battery in which the metal hydride is used. Through exposure of an average of 2.7 or more grain boundary phases at the surface of the metal hydride particles, it becomes possible to increase the discharge capacity of the alkaline storage battery even when the metal hydride is produced without resorting to a high-cost and low-productivity process such as those in the related art. By adopting such features, therefore, metal hydride particles can be provided that allow increasing discharge capacity, at a low cost and with high productivity.

A second aspect of the invention relates to metal hydride particles that have a main phase having a body-centered cubic structure, and that have a grain boundary phase including Ti and Ni. In a scanning electron microscopy observation image of the metal hydride particles before storage of hydrogen, an average of 2.7 or more grain boundary phases are exposed at a peripheral portion of the metal hydride particles, and an average particle size of the metal hydride particles is equal to or greater than 84 μm.

A third aspect of the invention relates to an electrode for an alkaline storage battery having metal hydride particles obtained from the metal hydride of the first aspect of the invention, or metal hydride particles according to the second aspect. The metal hydride particles according to the first or second aspect of the invention allow increasing discharge capacity, at a low cost and with high productivity. Therefore, an electrode for an alkaline storage battery can be provided that allows increasing discharge capacity, at a low cost and with high productivity, by using, in the electrode for an alkaline storage battery, the metal hydride particles according to the first or second aspect of the invention.

A fourth aspect of the invention relates to an alkaline storage battery having an alkaline electrolyte and the electrode for an alkaline storage battery according to the third aspect of the invention. The electrode for an alkaline storage battery according to the third aspect of the invention allows increasing discharge capacity, at a low cost and with high productivity. Therefore, an alkaline storage battery that allows increasing discharge capacity, at a low cost and with high productivity, can be provided by using, in the alkaline storage battery, the electrode for an alkaline storage batterys according to the third aspect of the invention.

The invention succeeds thus in providing a metal hydride, metal hydride particles, an electrode for an alkaline storage battery having the metal hydride particles, and an alkaline storage battery having the electrode, that allow increasing discharge capacity, at a low cost and with high productivity.

### BRIEF DESCRIPTION OF THE DRAWINGS

Features, advantages, and technical and industrial significance of exemplary embodiments of the invention will be described below with reference to the accompanying drawings, in which like numerals denote like elements, and, wherein:

FIG. 1 is a diagram for explaining a metal hydride and metal hydride particles, before crushing;

FIG. 2 is a diagram for explaining a metal hydride particle 1 of the invention;

FIG. 3 is a diagram for explaining an electrode for alkaline storage batteries 12 of the invention and an alkaline storage battery 10 of the invention;

FIG. 4 is a diagram illustrating X-ray diffraction analysis results of a TiVCrNi alloy;

FIG. 5 is a diagram illustrating an image of scanning electron microscopy (SEM) observation of a TiVCrNi alloy;

FIG. 6 is a diagram illustrating an example of circles having the diameter of the average particle size D₅₀ of metal hydride particles, drawn over the entire SEM image; FIG. 7 is a diagram for explaining the relationship between discharge capacity and X/Y;

FIG. 8 is a diagram for explaining a metal hydride (MH) of homogeneous composition; and

FIG. 9 is a diagram for explaining a metal hydride that has a main phase having a body-centered cubic structure and a grain boundary phase having Ti and Ni as main constituent elements.

### DETAILED DESCRIPTION OF EMBODIMENTS

The invention will be explained next with reference to accompanying drawings. The embodiments illustrated below are examples of the invention, but the latter is not limited to the embodiments.

1. Metal hydride particles

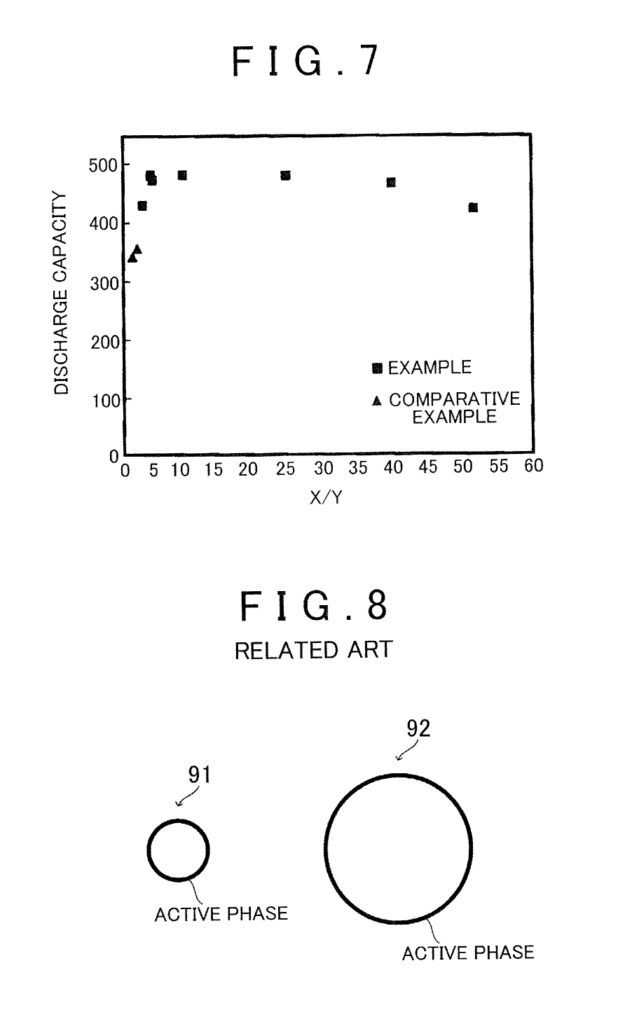

When a metal hydride (hereafter referred to as MH) of substantially homogeneous composition throughout the alloy is used in an electrode of an alkaline storage battery, the entire surface of the metal hydride functions as active sites of electrode reactions. Accordingly, an MH of homogeneous composition is not prone to result in changes in performance of the alkaline storage battery, even when the magnitude of the particle size is modified, and thus MHs of homogeneous composition, in a fine-powder state of small particle size, have come to be used, from the viewpoint of, for instance, facilitating the occurrence of electrode reactions through an increase in surface area. FIG. 8 illustrates, in a simplified manner, an MH 91 of homogeneous composition and of small particle size and an MH 92 of homogeneous composition and of particle size larger than that of MH 91 of homogeneous composition. In a case where a metal hydride that includes a main phase having a body-centered cubic structure and a grain boundary phase having Ti and Ni as main constituent elements (hereafter also referred to as “TiNi-containing MH”) is used in an electrode of an alkaline storage battery, then the grain boundary phase that is exposed at the surface functions as active sites. Accordingly, the performance of the alkaline storage battery is difficult to enhance even when using, in the alkaline storage battery, a TiNi-containing MH in which the grain boundary phase is not exposed at the surface.

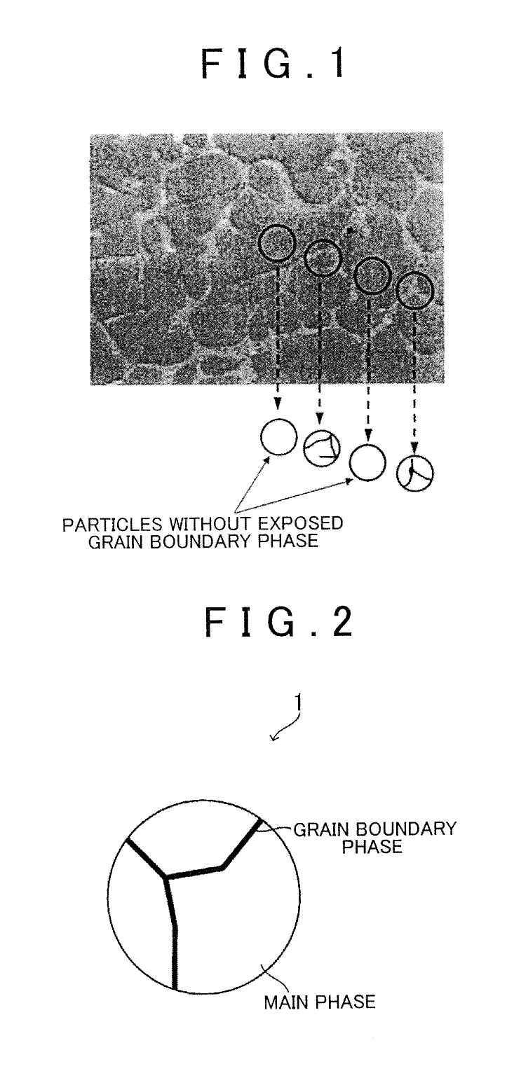

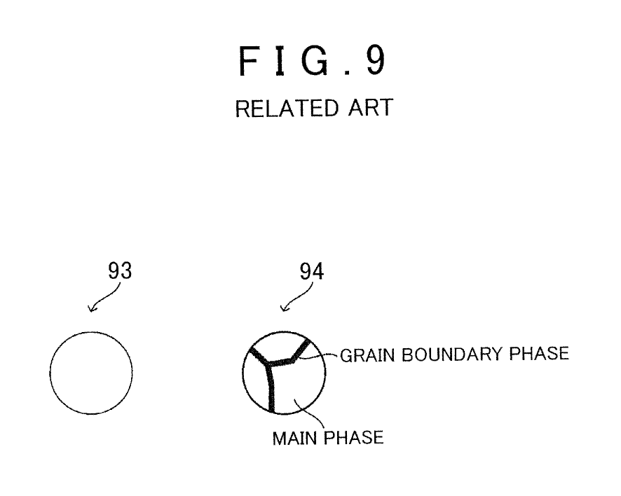

FIG. 1 is a SEM image for explaining a TiNi-containing MH before crushing. As illustrated in FIG. 1, a grain boundary phase in the TiNi-containing MH is present in the form of a mesh, such that the main phase is divided into a plurality of regions by the grain boundary phase. A conceivable production scheme of TiNi-containing MH microparticles out of such TiNi-containing MH may involve producing microparticles in which the grain boundary phase is not exposed at the surface and microparticles in which the grain boundary phase is exposed at the surface, as illustrated in FIG. 1. As described above, the performance of the alkaline storage battery is difficult to enhance in the case of TiNi-containing MH microparticles in which a grain boundary phase is not exposed at the surface. Accordingly, a method such as liquid quenching or the like can be conceivably resorted to from the viewpoint, for instance, of facilitating production of the TiNi-containing MH microparticles in which a grain boundary phase is exposed at the surface. However, such a method suffers from high costs and low productivity. FIG. 9 illustrates, in a simplified manner, a TiNi-containing MH microparticle 93 in which a grain boundary phase is not exposed at the structure and a TiNi-containing MH microparticle 94 in which a grain boundary phase is exposed at the surface.

The inventors conducted extensive studies on techniques for obtaining TiNi-containing MH particles having a grain boundary phase exposed at the surface, without resorting to a high-cost, low-productivity method such as liquid quenching. As a result, the inventors found that the discharge capacity of an alkaline storage battery can be increased, even for TiNi-containing MH particles that are produced through an ordinary melting process, which is not a high-cost low-productivity method such as liquid quenching, by prescribing X/Y≧2.7, where X is the number of intersections appearing in the entire SEM image of the TiNi-containing MH, before storage of hydrogen, between the grain boundary phase appearing in the SEM image, and circles having the diameter of the average particle size D₅₀ of the metal hydride particles obtained from the TiNi-containing MH, and where Y denotes the number of circles drawn in the SEM image, and by prescribing the average particle size D₅₀ of the TiNi-containing MH particles to be equal to or greater than 84 μm. FIG. 2 illustrates, in a simplified manner, a TiNi-containing MH particle 1 (metal hydride particle 1) of an embodiment of the invention. As illustrated in FIG. 2, the TiNi-containing MH particle 1 of the embodiment of the invention is larger than the TiNi-containing MH microparticle 94 in which a grain boundary phase is exposed at the surface, illustrated in FIG. 9.

The value of X/Y is not particularly limited, so long as it is equal to or greater than 2.7. Preferably, X/Y is equal to or smaller than 51.2, from the viewpoint of achieving a form wherein discharge capacity is increased readily. More preferably, X/Y is equal to or smaller than 39.1. From a similar viewpoint, X/Y is preferably equal to or greater than 3.9.

The main phase may be a metallic phase of body-centered cubic structure. Examples of main phases exhibiting such a feature include that in the TiVCrNi alloy in the Examples described below, but the main phase need not necessarily contain all of these elements. Although Ti and V are required in order for the alloy to have a body-centered cubic structure, the TiVCrNi alloy may be for instance a TiVNi alloy containing no Cr, or a TiV alloy containing no Cr or Ni.

In the embodiment of the invention the grain boundary phase is a phase having Ti and Ni as main constituent elements. Herein, the feature “having Ti and Ni as main constituent elements” indicates that the total content of Ti and Ni in the grain boundary phase is equal to or greater than 70 mass %. Examples of elements other than Ti and Ni and that make up the grain boundary phase include, for instance, elements derived from the main phase (constituent elements of the main phase). The content of Ti in the grain boundary phase can be set to 20≦Ti≦80 (units in mol %, likewise hereafter), the content of Ni can be set to 20≦Ni≦80, and the content of elements M, other than Ti and Ni and included in the grain boundary phase, can be set to 0≦M≦30.

2. Electrode for alkaline storage batteries, and alkaline storage battery

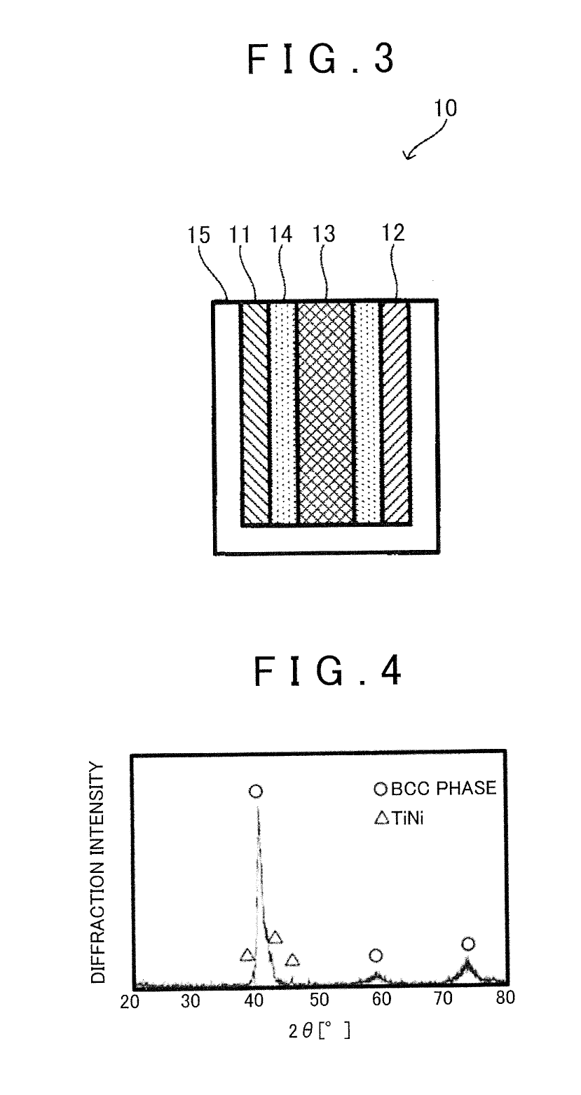

FIG. 3 is a diagram for explaining an electrode for alkaline storage batteries and an alkaline storage battery in an embodiment of the invention. FIG. 3 illustrates a simplified configuration in which members other than electrodes, an electrolyte, a separator and an exterior body, have been omitted.

An alkaline storage battery 10 illustrated in FIG. 3 is a nickel-metal hydride battery having a positive electrode 11 and a negative electrode 12, a separator 13, an alkaline electrolyte solution 14, and an exterior body 15 in which the foregoing are accommodated. The positive electrode 11 can be produced as a result of a process that involves coating a conductive porous substrate with a paste-like composition that is produced by mixing a positive electrode active material, a conductive aid and a binder, drying the coated substrate, and pressing thereafter the whole. The negative electrode 12 can be produced as a result of a process that involves coating a conductive porous substrate with a paste-like composition that is produced through mixing of the metal hydride particles of the embodiment of the invention, a conductive aid and a binder, drying the coated substrate, and pressing thereafter the whole. The separator 13 is a nonwoven fabric, and the exterior body 15 is made up of a substance that is stable towards the electrolyte solution 14. As described above, the metal hydride particles of the embodiment of the invention are used in the negative electrode 12, and hence the negative electrode 12 is the electrode for alkaline storage batteries of the embodiment of the invention.

The metal hydride particles of the embodiment of the invention allow increasing discharge capacity, and hence using the metal hydride particles in the negative electrode 12 makes it possible to provide a negative electrode 12 (electrode for alkaline storage batteries) that allows increasing discharge capacity. By adopting a configuration having the negative electrode 12 it becomes thus possible to provide an alkaline storage battery 10 whose the discharge capacity can be increased.

Other features of the electrode for alkaline storage batteries (negative electrode 12) of the embodiment of the invention are not particularly limited, so long as metal hydride particles of the embodiment of the invention are used therein, and so long as the electrode for alkaline storage batteries of the embodiment of the invention is configured to function as an electrode for alkaline storage batteries. The negative electrode 12 may be of a form in which no conductive aid or binder is utilized. However, a conductive aid is preferably used, and a binder is likewise preferably used, from the viewpoint of achieving a form where the performance of the alkaline storage battery that uses the negative electrode 12 is readily increased. A conventional conductive aid such as a nickel powder can be used, as appropriate, in a case where a conductive aid is used in the negative electrode 12. A conventional binder such as carboxymethyl cellulose (CMC) or polyvinyl alcohol (PVA) can be used, as appropriate, in a case where a binder is used in the negative electrode 12.

Other features of the alkaline storage battery of the embodiment of the invention are not particularly limited, provided that the electrode for alkaline storage batteries of the embodiment of the invention is used in the battery, and provided that the alkaline storage battery of the embodiment of the invention is configured to function as an alkaline storage battery.

The positive electrode active material that is used in the positive electrode 11 is not particularly limited, so long as it is can be used as a positive electrode active material in nickel-metal hydride batteries, and for instance a conventional positive electrode active material such as nickel hydroxide can be appropriately used herein. The conductive aid that is used in the positive electrode 11 is not particularly limited so long as it can be used in positive electrodes of nickel-metal hydride batteries, and for instance a conventional conductive aid such as cobalt oxide can be appropriately used herein. The binder that is used in the positive electrode 11 is not particularly limited so long as it can be used in positive electrodes of nickel-metal hydride batteries, and for instance substances similar to the binder that can be used in the negative electrode 12 can be likewise be appropriately used herein.

The separator 13 has holes through which ions can move between the positive electrode 11 and the negative electrode 12. As the separator 13, a conventional substance can be used that is capable of withstanding the environment, and that allows preventing short-circuits, during operation of the alkaline storage battery 10. Examples of such substances include, for instance, conventional nonwoven fabrics.

A conventional water-soluble liquid that is alkaline and that can be used as an electrolyte solution in nickel-metal hydride batteries can be utilized herein as the electrolyte solution 14. Examples of such an electrolyte solution 14 include, for instance, conventional electrolyte solutions, for instance potassium hydroxide aqueous solutions.

A conventional exterior body capable of withstanding the environment during operation of the alkaline storage battery 10 can be appropriately used as the exterior body 15.

A nickel-metal hydride battery and a negative electrode for nickel-metal hydride batteries have been illustrated as embodiments of the invention, but the invention is not limited to these embodiments. The alkaline storage battery of the invention may be a secondary battery that utilizes an alkaline electrolyte, but may be a battery of other form, for instance an air battery or the like. The electrode for alkaline storage batteries of the invention can be used as a negative electrode in such batteries of other form (for instance, as a negative electrode for air batteries).

The invention will be further explained next with reference to Examples.

(1) Production of a Metal Hydride (Preparation Step)

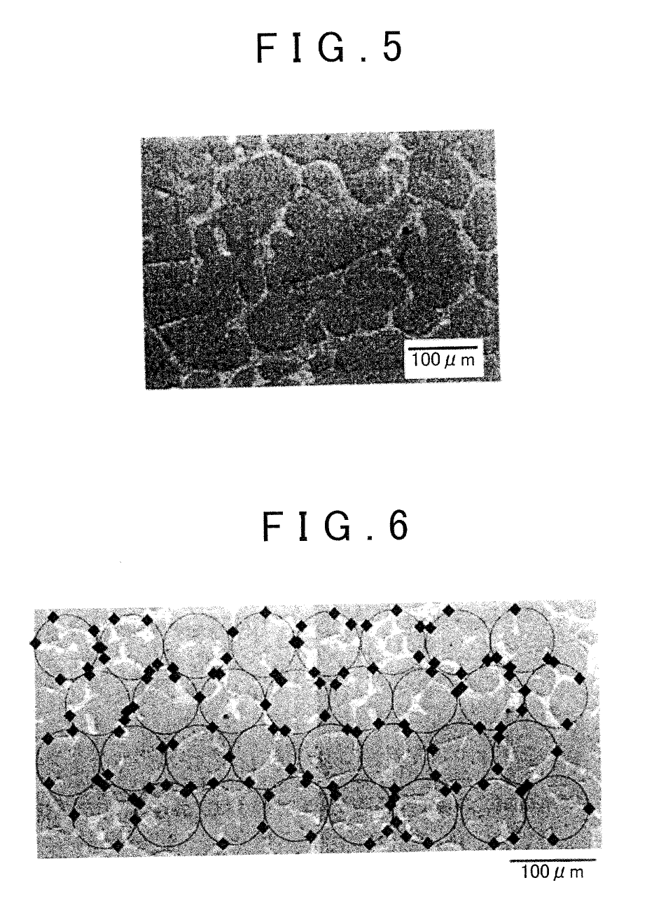

Herein a TiVCrNi alloy having composition ratios Ti:V:Cr:Ni=26:56:8:10 was produced through melting, by arc melting, of pure Ti (purity 99.9%, by Kojundo Chemical Laboratory Co., Ltd.), pure V (purity 99.9%, by Kojundo Chemical Laboratory Co., Ltd.), pure Cr (purity 99.9%, by Kojundo Chemical Laboratory Co., Ltd.) and pure Ni (purity 99.9%, by Kojundo Chemical Laboratory Co., Ltd.). The produced TiVCrNi alloy was analyzed by X-ray diffraction, using an X-ray diffractometer (RINT-TTRIII, by Rigaku Corporation), to elucidate the crystal structure of the alloy. The results are depicted in FIG. 4, which reveals that the produced TiVCrNi alloy was an alloy having a body-centered cubic structure as a main phase, and having partly a TiNi phase. A cross-section of the produced TiVCrNi alloy was observed using a scanning electron microscope (S-4500, by Hitachi Ltd.). Specifically, the above observation involved firstly cutting a lump of metal, after melting by arc melting, using a precision cutting machine (model HS-100, by Heiwa Technica Co., Ltd.), to yield a cut piece. The obtained cut piece was embedded thereafter in a conductive resin and was polished using a polishing machine. Final polishing by the polishing machine involved buffing, and the cut surface after buffing was observed using a scanning electron microscope. The results are depicted in FIG. 5, which reveals that the TiNi phase (grain boundary phase) in the produced TiVCrNi alloy was distributed in the form of a three-dimensional mesh within the main phase.

In order to remove adsorbed gas from the surface of the produced TiVCrNi alloy, before hydrogenation of the latter, the TiVCrNi alloy was held in a reduced-pressure environment (1 Pa or less) at 250° C. The hydrogenation reaction progresses smoothly as a result. Thereafter, hydrogenation was performed through application of 30 MPa of hydrogen gas pressure at normal temperature, followed by desorption of hydrogen through depressurization down to 1 Pa or less. This operation was repeated a total of two times. Specifically, there was performed an operation of hydrogenation-hydrogen desorption-hydrogenation-hydrogen desorption.

The sample after desorption of hydrogen was classified under the conditions given in Table 1 while being mechanically crushed using an agate mortar, to yield metal hydride particles having a predetermined particle size distribution (Example 1 to Example 7, Comparative example 1 to Comparative example 2). The average particle size D₅₀ of the metal hydride particles thus classified was determined using a laser diffraction-type particle size distribution measuring apparatus (SALD-2300, by Shimadzu Corporation). Thereafter, circles having the diameter of the average particle size D₅₀ of the metal hydride particles were drawn over the entire SEM image, in such a manner that mutually adjacent circles were in contact with each other but without overlapping, and the X/Y value of the classified metal hydride particles was calculated. FIG. 6 illustrates an example (Example 3) of circles having the diameter of the average particle size D₅₀ of the metal hydride particles, drawn over the entire SEM image. In the example illustrated in FIG. 6, the number of intersections of the circles and the TiNi phase is X=124, and the number of circles is Y=32. Accordingly, X/Y=3.875≅3.9. Table 1 gives the X/Y values that were worked out for the respective metal hydride particles, along with the classification condition and average particle size D₅₀.

TABLE 1

| | | Average | | |
|---|---|---|---|---|
| | | particle | | Discharge |
| | Alloy classification | size D50 | | capacity |
| | condition | D₅₀ (μm) | X/Y | (mAh/g) |
| Working ex. 1 | ≦300 μm | 128 | 4.2 | 474 |
| Working ex. 2 | 65 μm to 100 μm | 84 | 2.7 | 431 |
| Working ex. 3 | 100 μm to 150 μm | 109 | 3.9 | 481 |
| Working ex. 4 | 150 μm to 300 μm | 228 | 8.5 | 484 |
| Working ex. 5 | 300 μm to 500 μm | 402 | 23.5 | 481 |
| Working ex. 6 | 500 μm to 750 μm | 635 | 39.1 | 467 |
| Working ex. 7 | 750 μm to 1000 μm | 891 | 51.2 | 423 |
| Comparative | ≦65 μm | 32 | 1.2 | 344 |
| ex. 1 | | | | |
| Comparative | ≦150 μm | 78 | 1.9 | 358 |
| ex. 2 | | | | |

<Production of Negative Electrodes>

A conductive aid (Ni powder (by Fukuda Metal Foil & Powder Co., Ltd.)) and two types of binder (CMC (by Dai-ichi Kogyo Seiyaku Co., Ltd.) and PVA (by Wako Pure Chemical Industries, Ltd.)) were added to the respective metal hydride particles after classification, to a weight ratio of metal hydride particle: conductive aid :CMC:PVA=49:49:1:1, and the whole was then kneaded to produce thereby a respective paste-like composition. Each paste-like composition was coated onto porous nickel, the whole was dried at 80° C., and thereafter the whole was roll-pressed through application of 490 MPa, to produce thereby a respective negative electrode.

<Production of a Positive Electrode>

A paste-like composition was produced by adding cobalt oxide CoO (by Kojundo Chemical Laboratory Co., Ltd.) and two types of binder (CMC (by Dai-ichi Kogyo Seiyaku Co., Ltd.) and PVA (by Wako Pure Chemical Industries, Ltd)) to nickel hydroxide Ni(OH)₂ (by Tanaka Chemical Corporation), to a weight ratio of Ni(OH)₂:CoO:CMC:PVA=88:10:1:1, followed by kneading of the whole. The paste-like composition was coated onto porous nickel, the whole was then dried at 80° C., and was thereafter roll-pressed through application of 490 MPa, to produce thereby a positive electrode.

<Production of an Electrolyte Solution>

An electrolyte solution having a concentration of 7.15 M was produced by mixing pure water with a potassium hydroxide reagent by Nacalai Tesque, Inc.

<Production of Batteries>

A nickel-metal hydride battery was produced using an acrylic container filled with 90 ml of the produced electrolyte solution, and using the positive electrode and negative electrodes produced as a result of the above-described process, together with a reference electrode (Hg/HgO electrode).

<Battery Evaluation>

Discharge capacity was measured through charge and discharge at a current rate of 0.1 C and a battery-evaluation environmental temperature of 25° C., using a charge and discharge cycle tester VMP3 by Bio-Logic. The results are given in Table 1. FIG. 7 illustrates the relationship between the obtained discharge capacity and X/Y.

<Results>

As Table 1 and FIG. 7 reveal, the batteries that utilized the metal hydride particles of Example 1 to Example 7, where X/Y≧2.7 and the average particle size D₅₀ was equal to or greater than 84 μm, exhibited a larger discharge capacity than that of batteries that utilized the metal hydride particles of Comparative example 1 and Comparative example 2, in which the above condition was not satisfied. This can be conceivably ascribed to the fact that the metal hydride particles of Example 1 to Example 7 exhibited a high ratio of particles in which the grain boundary phase was exposed at the surface, despite having been produced in accordance with a process that affords high productivity at a low cost, namely hydrogenation, hydrogen desorption, and crushing, without resorting to liquid quenching or the like, and, accordingly, the batteries that used such metal hydride particles exhibited enhanced discharge capacity. By contrast, it was found that in the metal hydride particles of Comparative example 1 and Comparative example 2, where the average particle size D₅₀ was small, a considerable number of particles were present in which the grain boundary phase was not exposed at the surface, and, as a result, the batteries that utilized these metal hydride particles exhibited decreased discharge capacity.

As Table 1 and FIG. 7 reveal, X/Y is equal to or greater than 2.7 and equal to or smaller than 51.2 in Example 1 to Example 7. The discharge capacity enhancing effect was more pronounced, in Example 1 to Example 7, in those cases where X/Y was equal to or greater than 3.9. The discharge capacity enhancing effect was also pronounced for X/Y up to 39.1. It was thus found that the Examples of the invention succeeded in providing metal hydride particles that allow increasing discharge capacity, at a low cost and with high productivity, and in providing an electrode for alkaline storage batteries that uses the metal hydride particles, as well as an alkaline storage battery that uses the electrode.

What is claimed is:

1. A metal hydride, comprising:
a main phase having a body-centered cubic structure; and
a grain boundary phase including Ti and Ni,
wherein the metal hydride satisfies X/Y≧2.7, where X is the number of intersections between circles of a diameter equal to or greater than 84 μm and the grain boundary phase that appears in a scanning electron microscopy observation image of the metal hydride, before storage of hydrogen, the intersections being obtained by drawing the circles over the entire scanning electron microscopy observation image, and Y is the number of the circles drawn on the scanning electron microscopy observation image.

2. The metal hydride according to claim 1, wherein
the circles are drawn such that the circles are closest to each other over the entire scanning electron microscopy observation image.

3. The metal hydride according to claim 1, wherein
the diameters of the circles are 900 μm or smaller.

4. An electrode for an alkaline storage battery, comprising:
metal hydride particles obtained from the metal hydride according to claim 1.

5. An alkaline storage battery, comprising:
an alkaline electrolyte; and
the electrode according to claim 4.

6. Metal hydride particles, comprising:
a main phase having a body-centered cubic structure; and
a grain boundary phase including Ti and Ni,
wherein (i) in a scanning electron microscopy observation image of the metal hydride particles before storage of hydrogen, an average of 2.7 or more grain boundary phases are exposed at a peripheral portion of the metal hydride particles, and
(ii) an average particle size of the metal hydride particles is equal to or greater than 84 μm.

7. An electrode for an alkaline storage battery, comprising:
the metal hydride particles according to claim 6.

8. An alkaline storage battery, comprising:
an alkaline electrolyte; and
the electrode according to claim 7.
